(19) United States
(12) Patent Application Publication
(10) Pub. No.: US 2020/0274383 A1
(43) Pub. Date: Aug. 27, 2020

(54) PORTABLE ELECTRONIC APPARATUS AND BATTERY POWER MANAGEMENT METHOD THEREOF

(71) Applicants: Chi-Ming Lan, Taipei City (TW); Yi-Hsun Lin, Taipei City (TW); Chih-Tarng Chuang, Taipei City (TW)

(72) Inventors: Chi-Ming Lan, Taipei City (TW); Yi-Hsun Lin, Taipei City (TW); Chih-Tarng Chuang, Taipei City (TW)

(73) Assignee: COMPAL ELECTRONICS, INC., Taipei City (TW)

(21) Appl. No.: 16/739,121

(22) Filed: Jan. 10, 2020

(30) Foreign Application Priority Data
Feb. 25, 2019 (TW) 108106212

(51) Int. Cl. H02J 7/00

(52) U.S. Cl. CPC H02J 7/00714; H02J 7/0048

(57) ABSTRACT

A portable electronic apparatus and a battery power management method thereof are provided. The method includes the following steps. A discharge current of a battery is detected. Whether the discharge current is greater than a current threshold within a predetermined period is determined. If the discharge current is not greater than the current threshold within the predetermined period, whether a fully charge capacity of the battery is less than a battery capacity threshold is determined. If the fully charge capacity of the battery is not less than the battery capacity threshold, a relative state of charge of the battery is controlled to be maintained within a first power range. If the fully charge capacity of the battery is less than the battery capacity threshold, the relative state of charge of the battery is controlled to be maintained within a second power range.

### CROSS-REFERENCE TO RELATED APPLICATION

This application claims the priority benefit of Taiwan application serial no. 108106212, filed on Feb. 25, 2019. The entirety of the above-mentioned patent application is hereby incorporated by reference herein and made a part of this specification.

### BACKGROUND

### 1. Field of the Invention

The invention relates to a battery control technique, and more particularly, to a portable electronic apparatus and a battery power management method thereof.

### 2. Description of Related Art

With the advancement of technology, portable electronic apparatuses such as notebook computers and smart phones also become more popular each day. In order to facilitate the user to use these portable electronic apparatuses in a powerless environment, a rechargeable battery is usually disposed in the portable electronic apparatus to provide power to the portable electronic apparatus in the powerless environment. For the battery of the portable electronic apparatus, in addition to the manufacturing research and development focused on small volume and high power storage capacity, an operating life of the battery is also an important issue to be addressed.

Further, as the number of uses and time increases, an ageing phenomenon of the battery will cause the fully charge capacity (FCC) of the battery to decrease. That is to say, a power storage capacity of the battery will be gradually degraded. The so-called fully charge capacity of the battery refers to the amount of power stored by the battery being fully charged. In general, when the portable electronic apparatus is connected to an external power source, power is provided to the portable electronic apparatus by the external power source (e.g., supply mains) and the battery is maintained in a fully charged state. However, when the portable electronic apparatus is connected to the external power source for a long time, although the battery does not provide power to the portable electronic apparatus, the amount of power stored by the battery may still be reduced due to a self-discharge phenomenon. Therefore, when the amount of power of the battery is discharged to a certain extent due to the self-discharge phenomenon (e.g., reduced from the fully charged state to 95% the amount of power remained), a charging mechanism of the portable electronic apparatus will drive the battery to be charged and restored to the fully charged state. In this way, when the portable electronic apparatus is continuously connected to the external power source, the battery will be repeatedly charged and discharged due to the self-discharge phenomenon. Yet, the act of repeatedly charging the battery will cause the fully charge capacity of the battery to decrease progressively and rapidly, and will then accelerate an aging speed of the battery.

### SUMMARY OF THE INVENTION

Accordingly, the invention provides a portable electronic apparatus and a battery power management method, which are capable of delay the aging speed and effectively extending the operating life of the battery.

The invention proposes a battery power management method adapted to a portable electronic apparatus having a battery. The method includes the following steps. A discharge current of a battery is detected. Whether the discharge current is greater than a current threshold within a predetermined period is determined. If the discharge current is not greater than the current threshold within the predetermined period, whether a fully charge capacity of the battery is less than a battery capacity threshold is determined. If the fully charge capacity of the battery is not less than the battery capacity threshold, a relative state of charge (RSOC) of the battery is controlled to be maintained within a first power range. If the fully charge capacity of the battery is less than the battery capacity threshold, the relative state of charge of the battery is controlled to be maintained within a second power range.

From another aspect, the invention proposes a portable electronic apparatus that includes a battery and a controller. The battery supplies a power to the portable electronic apparatus, and the controller controls the battery to be charged or discharged. The controller detects a discharge current of the battery, and determines whether the discharge current is greater than a current threshold within a predetermined period. If the discharge current is not greater than the current threshold within the predetermined period, the controller determines whether a fully charge capacity of the battery is less than a battery capacity threshold. If the fully charge capacity of the battery is not less than the battery capacity threshold, the controller controls a relative state of charge of the battery to be maintained within a first power range. If the fully charge capacity of the battery is less than the battery capacity threshold, the controller controls the relative state of charge of the battery to be maintained within a second power range.

Based on the above, according to the embodiments of the invention, when the portable electronic apparatus is connected to the external power source for a long time, by controlling the relative state of charge of the battery to be maintained within a particular power range, the operating life of the battery may be extended.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a portable electronic apparatus according to an embodiment of the invention.

FIG. 2 is a flowchart illustrating a battery power management method according to an embodiment of the invention.

FIG. 3 is a schematic diagram illustrating a portable electronic apparatus according to an embodiment of the invention.

FIG. 4 is a flowchart illustrating a battery power management method according to an embodiment of the invention.

FIG. 5 illustrates a relationship chart of battery capacity versus time.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

Some embodiments of the invention are described in details below by reference with the accompanying drawings, and as for reference numbers cited in the following description, the same reference numbers in difference drawings are referring to the same or like parts. The embodiments are merely a part of the disclosure without disclosing all possible embodiments of the disclosure. More specifically, these embodiments are simply examples of battery power management method and the portable electronic apparatus recited in claims of the disclosure.

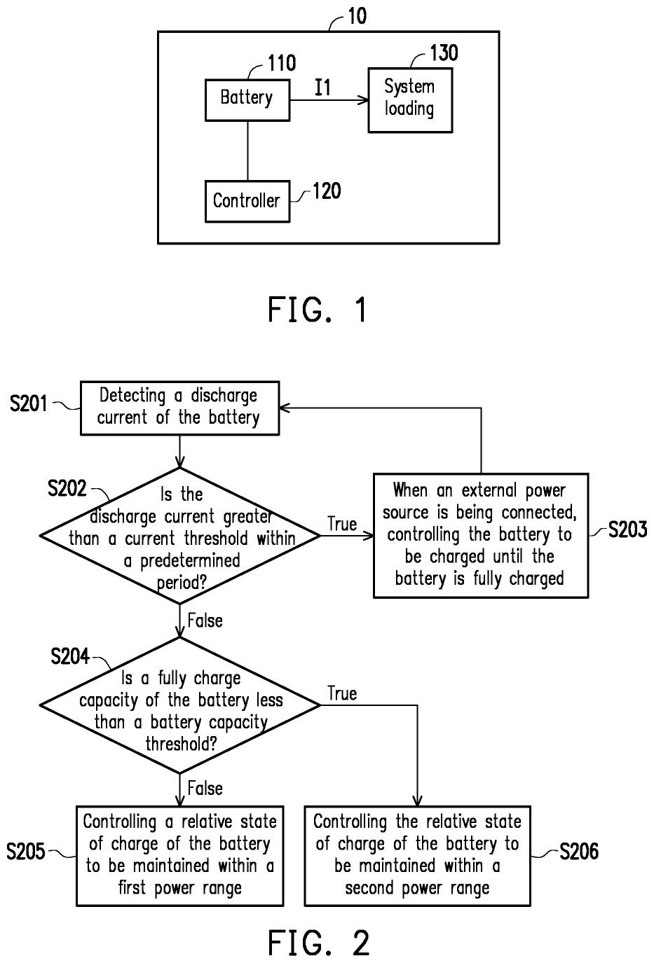

FIG. 1 is a schematic diagram illustrating a portable electronic apparatus according to an embodiment of the invention. With reference to FIG. 1, a portable electronic apparatus 10 includes a battery 110, a controller 120 and a system loading 130. The portable electronic apparatus 10 is adapted to receive a DC power source required in operation from an external part (which may be provided by a power adapter, for example), and convert the DC power source into a working power source for operating internal circuits and/or charging the battery 110. Here, the portable electronic apparatus 10 may be, for example, various electronic devices like a notebook computer, a tablet computer, a smart phone, a personal digital assistant (PDA) or a game console, but the invention is not limited thereto.

The battery 110 is used as a main power supply source of the portable electronic apparatus 10 for allowing the system loading 130 to obtain power and thereby operate normally when the portable electronic apparatus 10 is not connected to an external AC power source through the power adapter. Further, the battery 110 may also be charged when the portable electronic apparatus 10 is connected to the external AC power source. The system loading 130 is a hardware part in the portable electronic apparatus 10 for providing a specific function, and includes a central processing unit (CPU), a chipset, a memory, a hard drive, etc.

The controller 120 is coupled to the battery 10 and is able to control the battery 10 to be charged or discharged. The controller 120 is, for example, a processor or an embedded controller (EC), but the invention is not limited thereto. In an embodiment, the controller 120 can execute firmware stored in a recording medium to realize power capacity management functions. Detailed steps regarding how the controller 120 manages a battery power will be described below with reference to embodiments.

FIG. 2 is a flowchart illustrating a battery power management method according to an embodiment of the invention. The battery power management method of this embodiment is adapted to the portable electronic apparatus 10 in FIG. 1. Each step in the battery power management method of this embodiment is described below with reference to each element of the portable electronic apparatus 10 in FIG. 1. However, each process in the battery power management method may be adjusted according to the implementation situation, and are not limited thereto.

Referring to FIG. 1 and FIG. 2 together, in step S201, the controller 120 detects a discharge current I1 of the battery. In step S202, the controller 120 determines whether the discharge current I1 is greater than a current threshold within a predetermined period.

Normally, when the portable electronic apparatus 10 is connected to the external AC power source through the power adapter, the battery 110 does not provide power to the system loading 130. When the battery 110 does not provide power to the system loading 130, the discharge current I1 output by the battery is ideally 0 A, but the battery 110 may in fact output a weak current due to the self-discharge phenomenon or other factors. However, there is a considerable difference between magnitudes of the weak current and the current output by the battery 110 for providing power to the system loading 130. Based on this, the controller 120 can determine whether or not the battery 110 provides power to the system loading 130 by detecting a current magnitude of the discharge current I1. That is to say, by detecting the current magnitude of the discharge current I1, the controller 120 can determine the power stored in the battery 110 is being used.

In addition, the predetermined period is, for example, two or three days, and the like, and the invention is not limited thereto. A length of the predetermined period may be adjusted based on actual requirements. The current threshold is, for example, 5 milliamper (mA), but the invention is not limited thereto. Based on the determination in step S202, the controller 120 can determine whether the battery 110 has not provided power to the system loading 130 for the predetermined period (e.g., three days). In other words, when the controller 120 confirms that the discharge current I1 is not greater than the current threshold within the predetermined period, it indicates that the user has the portable electronic apparatus 10 connected to an external power source for a long time.

According to the above description, if the result of the determination in step S202 is False, it indicates that the battery 110 has provided power to the system loading 130 and thus the amount of power remained is decreased. Therefore, if the discharge current I1 is greater than the current threshold within the predetermined period, in step S203, when the portable electronic apparatus 10 is connected to the external power source, the controller 120 controls the battery 110 to be charged until the battery 110 is fully charged.

On the other hand, if the result of the determination in step S202 is True, it indicates that the battery 110 has not provided power to the system loading 130 for the predetermined period, and this may shorten the operating life of the battery 110. Therefore, if the discharge current I1 is not greater than the current threshold within the predetermined period, in step S204, the controller 120 determines whether a fully charge capacity of the battery is less than a battery capacity threshold. The fully charge capacity (FCC) of the battery 110 refers to the amount of power stored by the battery 110 being fully charged, wherein the unit of the fully charge capacity is generally in unit of ampere-hour (mAh). It should be noted that, a size of the fully charge capacity of the battery 110 can represent an aging degree of the battery 110.

In an embodiment, the battery capacity threshold is a product of a design capacity and a predetermined ratio of the battery 110. For instance, when the design capacity is 5000 mAh and the predetermined ratio is 50%, the battery capacity threshold will be 2500 mAh. Nonetheless, the predetermined ratio may be adjusted based on actual requirements, and the invention is not limited thereto. If the battery capacity threshold is 2500 mAh, when the controller 120 detects that the fully charge capacity of the battery 120 is less than 2500 mAh, it indicates that the battery 110 has aged and a battery capacity of the fully charged battery 120 becomes less than 50% of the design capacity.

Hence, if the result of the determination in step S204 is False, in step S205, the controller 120 controls a relative state of charge (RSOC) of the battery 110 to be maintained within a first power range. Conversely, if the result of the determination in step S204 is False, in step S206, the controller 120 controls the relative state of charge of the battery 110 to be maintained within a second power range. The relative state of charge is the percentage of the remained power and the battery capacity of fully charged battery, and the unit thereof is generally in unit of ampere-hour (mAh). The relative state of charge ranges from 0% to 100%. Thus, the relative state of charge is 100% when the battery is fully charged, and the relative state of charge is 0% when power is completely used up.

More specifically, if the fully charge capacity of the battery 110 is not less than the battery capacity threshold, it indicates that the battery 110 has not aged to a particular degree, and thus the controller 120 controls the relative state of charge of the battery 110 to be maintained within the first power range. Conversely, if the fully charge capacity of the battery 110 is less than the battery capacity threshold, it indicates that the battery 110 has aged to the particular degree, and thus in step S206, the controller 120 controls the relative state of charge of the battery 110 to be maintained within the second power range. Here, the first power range is different from the second power range. In other words, in the case where power is provided to the portable electronic apparatus 10 from the external power source for a long time, the controller 120 can determine to control the relative state of charge of the battery 110 within the different power ranges according to the aging degree of the battery 110. Based on this, in the case where power is provided to the portable electronic apparatus 10 from the external power source for a long time, as compared to the conventional technology in which the battery 110 is recovered to the fully charged state each time, by maintaining the relative state of charge of the battery 110 within a particular power range according to the embodiment of the invention, the ageing degree of the battery may be delayed.

How to maintain the RSOC of the battery 110 within the particular power range will be described below with reference to an embodiment.

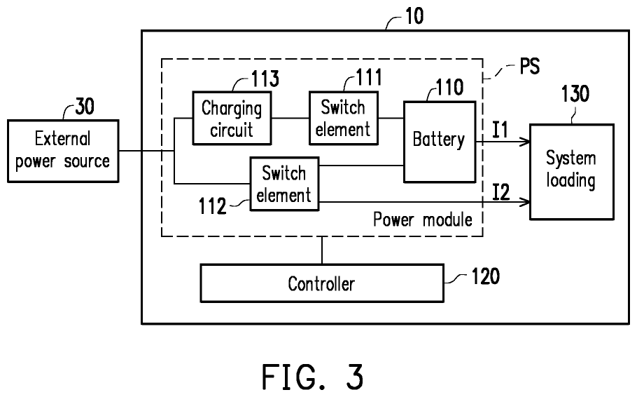

FIG. 3 is a schematic diagram illustrating a portable electronic apparatus according to an embodiment of the invention. With reference to FIG. 3, by controlling operations of a power module PS by the controller 120, the portable electronic apparatus 10 may be powered by an external power source 30 or the battery 110 to operate normally. In addition, by controlling the operations of the power module PS by the controller 120, the battery 110 may be charged accordingly.

The external power source 30 may be, for example, a combination of the external AC power source and the power adapter. The controller 120 is coupled to the power module PS to control the operations of the power module PS. The power module PS may include a charging circuit 113, a switching element 111, a switching element 112 and the battery 110. The charging module 113 is coupled to the switch element 111, and the switch element 111 is coupled to between the battery 110 and the charging circuit 113. The switch element 112 is coupled to the external power source 30, the battery 110 and the system loading 130.

By controlling an on-state of the switch element 111, the controller 120 can control the battery 110 to be charged or stopped being charged by the external power source 30. By controlling an on-state of the switch element 112, the controller 120 can control whether to provide power to the system loading 130 by the battery 110 or the external power source 30. That is to say, by controlling the on-state of the switch element 112, the controller 120 can determine to whether the system loading 130 obtains power from the discharge current I1 or a current 12 generated by the external power source 30. Nonetheless, FIG. 3 is merely an exemplary embodiment. The controller 120 may also control the battery 110 to be charged or discharged by other hardware configurations, and control an operating power source of the system loading 130 to be the external power source 30 or the battery 110.

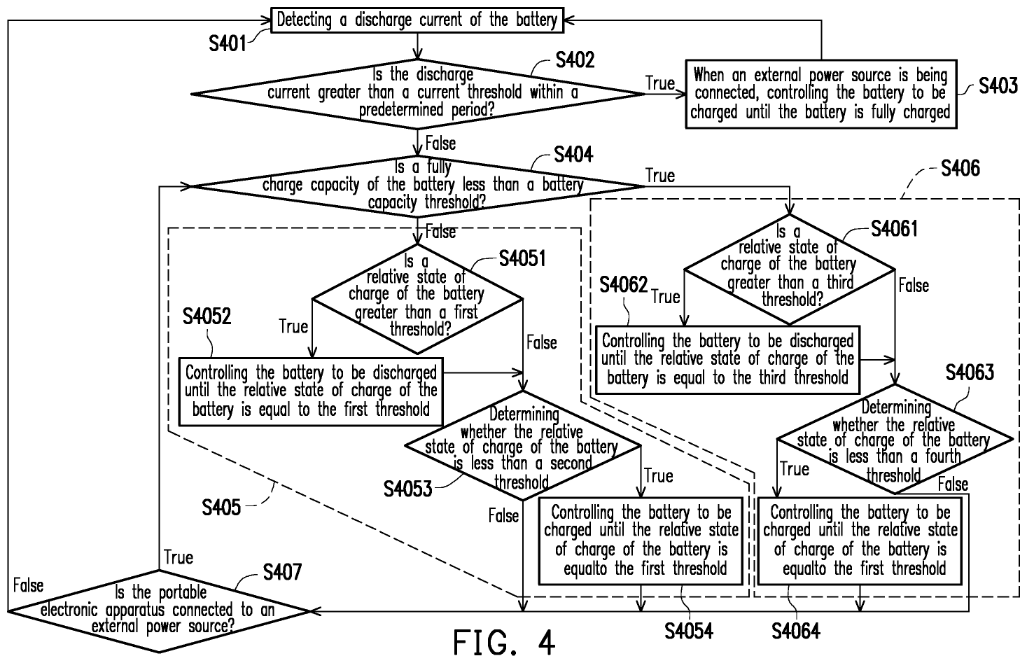

FIG. 4 is a flowchart illustrating a battery power management method according to an embodiment of the invention. The battery power management method of this embodiment is adapted to the portable electronic apparatus 10 depicted in FIG. 3. Each step in the battery power management method of this embodiment is described below with reference to each element in FIG. 3. However, each process in the battery power management method may be adjusted according to the implementation situation, and are not limited thereto.

Referring to FIG. 3 and FIG. 4 together, in step S401, the controller 120 detects a discharge current I1 of the battery 110. In step S402, the controller 120 determines whether the discharge current I1 is greater than a current threshold within a predetermined period. If the discharge current I1 is greater than the current threshold within the predetermined period (the result of the determination in step S402 is True), in step S403, when the portable electronic apparatus 10 is connected to the external power source 30, the controller 120 controls the battery 110 to be charged until the battery 110 is fully charged. If the discharge current I1 is not greater than the current threshold within the predetermined period (the result of the determination in step S402 is False), in step S404, the controller 120 determines whether a fully charge capacity of the battery 110 is less than a battery capacity threshold. Details of the above steps may refer to the descriptions for steps S201 to S204 in FIG. 2, which are not repeated hereinafter.

If the fully charge capacity of the battery 110 is not less than the battery capacity threshold (the result of the determination in step S404 is False), in step S405, the controller 120 controls the relative state of charge of the battery 110 to be maintained within a first power range. Here, step S405 may be implemented by step S4051 to S4054.

In step S4051, the controller 120 determines whether the relative state of charge of the battery 110 is greater than a first threshold. If the relative state of charge of the battery 110 is greater than the first threshold (the result of the determination in step S4051 is True), in step S4052, the controller 120 controls the battery 110 to be discharged until the relative state of charge of the battery 110 is equal to the first threshold. Specifically, through the switch elements 111 and 112, the controller 120 can control the battery 110 to be discharged, for example. Further, when the relative state of charge of the battery 110 is lowered to the first threshold through discharging, the controller 120 can control the battery 110 to stop being discharged.

If the relative state of charge of the battery 110 is not greater than the first threshold (the result of the determination in step S4051 is False), in step S4053, the controller 120 determines whether the relative state of charge of the battery 110 is less than a second threshold. On the other hand, after step S4052, the controller 120 also then determines whether the relative state of charge of the battery 110 is less than the second threshold in step S4053. If the relative state of charge of the battery 110 is less than the second threshold (the result of the determination in step S4053 is True), in the step S4051, the controller 120 controls the battery 110 to be charged until the relative state of charge of the battery 110 is equal to the first threshold. Specifically, through the switch element 111, the controller 120 can control the battery 110 to be charged, for example. Further, when the relative state of charge of the battery 110 is raised to the first threshold through charging, the controller 120 can control the battery 110 to stop being charged.

Here, the first threshold is greater than the second threshold, and a range between the first threshold and the second threshold is the first power range. For instance, the first threshold may be 60% and the second threshold may be 55%. In this case, the first power range ranges from 60% to 55%, but the invention is not limited thereto. By the implementation of step S4051 to step S4054, before the battery 110 is aged to a particular degree, the controller 120 can control the relative state of charge of the battery 110 to be maintained between 60% and 55%.

On the other hand, if the fully charge capacity of the battery 110 is less than the battery capacity threshold (the result of the determination in step S404 is True), in step S406, the controller 120 controls the relative state of charge of the battery 110 to be maintained within the second power range. Here, step S406 may be implemented by step S4061 to S4064.

In step S4061, the controller 120 determines whether the relative state of charge of the battery 110 is greater than a third threshold. If the relative state of charge of the battery 110 is greater than the third threshold (the result of the determination in step S4061 is True), in step S4062, the controller 120 controls the battery 110 to be discharged until the relative state of charge of the battery 110 is equal to the third threshold. Specifically, when the relative state of charge of the battery 110 is lowered to the third threshold through discharging, the controller 120 can control the battery 110 to stop being discharged.

If the relative state of charge of the battery 110 is not greater than the third threshold (the result of the determination in step S4061 is False), in step S4063, the controller 120 determines whether the relative state of charge of the battery 110 is less than a fourth threshold. On the other hand, after step S4062, the controller 120 also then determines whether the relative state of charge of the battery 110 is less than the fourth threshold in step S4063. If the relative state of charge of the battery 110 is less than the fourth threshold (the result of the determination in step S4063 is True), in the step S4064, the controller 120 controls the battery 110 to be charged until the relative state of charge of the battery 110 is equal to the third threshold. Specifically, when the relative state of charge of the battery 110 is raised to the third threshold through charging, the controller 120 can control the battery 110 to stop being charged.

Here, the third threshold is greater than the fourth threshold, and a range between the third threshold and the through discharging threshold is the second power range. For instance, the third threshold may be 80% and the fourth threshold may be 75%. In this case, the second power range ranges from 80% to 75%, but the invention is not limited thereto. By the implementation of step S4061 to step S40564, when the battery 110 is aged to the particular degree, the controller 120 can control the relative state of charge of the battery 110 to be maintained between 80% and 75%.

It is worth mentioning that, in an embodiment, the third threshold of the second power range is greater than the first threshold of the first power range, and the fourth threshold of the second power range is greater than the second threshold of the first power range. That is to say, an upper limit of the first power range is less than an upper limit of the second power range, and a lower limit of the first power range is less than a lower limit of the second power range. Specifically, when the battery 110 is aged to the particular degree, it indicates that the fully charge capacity of the battery 110 is reduced to a certain extent, and its power storage capacity is not as good as before. Based on that, when the battery 110 is aged to the particular degree, the controller 120 maintains the relative state of charge of the battery 110 within the higher second power range to prevent the portable electronic apparatus 10 from quickly running out of the battery after the user removes the external power source 30.

Returning to the processes in FIG. 4, after the relative state of charge of the battery 110 is maintained within the first power range or the seconds power range, in step S407, the controller 120 determines whether the portable electronic apparatus 10 is connected to the external power source 30. The controller 120 can determine whether the portable electronic apparatus 10 is connected to the external power source 30 by, for example, detecting the discharge current I1 of the battery 110, or determine whether the portable electronic apparatus 10 is connected to the external power source 30 by other methods.

If the portable electronic apparatus 10 is connected to the external power source 30 (the result of the determination in step S407 is True), the method returns to step S404, in which the controller 120 continues to determine whether the fully charge capacity of the battery 110 is less than the battery capacity threshold, and maintains the relative state of charge of the battery 110 within the particular power range. On the other hand, once the portable electronic apparatus 10 is not connected to the external power source 30 (the result of the determination in step S407 is False), the method returns to step S401, in which the controller 120 determines whether the discharge current I1 is greater than the current threshold within the predetermined period. It should be noted that, once the portable electronic apparatus 10 is not connected to the external power source 30, before the user connects the external power source 30 to the portable electronic apparatus 10 again, the discharge current I1 will continue to be greater than the current threshold until the battery 110 died. If the user connects the external power source 30 to the portable electronic apparatus 10 again before the battery 110 died, the controller 120 can control the battery 110 to be charged until the battery 110 is fully charged (step S403).

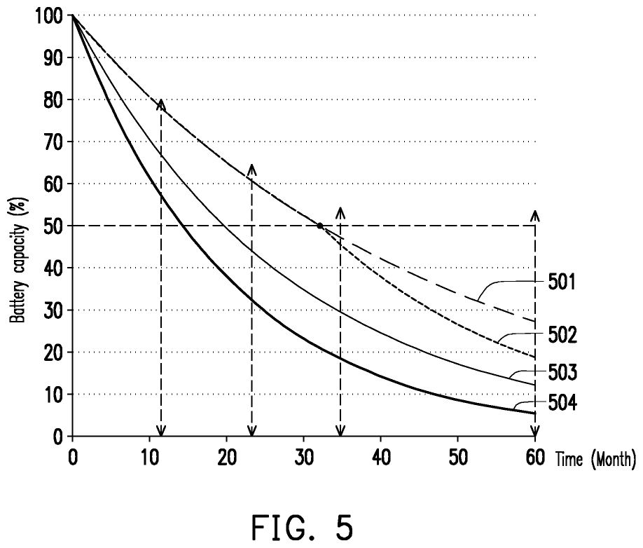

FIG. 5 illustrates a relationship chart of battery capacity versus time. Referring FIG. 5, a horizontal axis represents time (unit: month) and a vertical axis represents the battery capacity (unit: percentage). In FIG. 5, characteristic curves 501 to 504 are characteristic curves respectively representing battery capacities of the battery deferred over time under different conditions. When being connected to the external power source for a long time, if the battery power is not controlled and adjusted, the relative state of charge of the battery will vary, for example, between 100% and 95%, and the aging degree of the battery will be as shown by the characteristic curve 504. When being connected to the external power source for a long time, if the relative state of charge of the battery is controlled between 60% and 55% (within the first power range) without taking the aging degree into consideration, the aging degree of the battery will be as shown by the characteristic curve 501. When being connected to the external power source for a long time, if the relative state of charge of the battery is controlled between 80% and 75% (within the second power range) without taking the aging degree into consideration, the aging degree of the battery will be as shown by the characteristic curve 503.

In the condition where the battery power management method in the embodiments of the invention is applied, when being connected to the external power source for a long time, the relative state of charge of the battery will be changed from being maintained between 60% and 75% (within the first power range) to being maintained between 80% and 75% (within the second power range). In the example shown by FIG. 5, when the battery capacity of the battery becomes less than 50% due to aging (i.e., the fully charge capacity of the battery is less than 50% of the design capacity), the relative state of charge of the battery will be changed to be maintained between 80% and 75%. In such condition, the aging degree of the battery will be as shown by the characteristic curve 502.

In view of FIG. 5, in the condition where the portable electronic apparatus is connected to the external power source for a long time, if the battery capacity is not controlled at all, the most severe aging degree of the battery will be as shown by the characteristic curve 504. After studying the characteristic curve 501 and the characteristic curve 503, it can be known that, in comparison with continuously controlling the relative state of charge of the battery between 60% and 55%, continuously controlling the relative state of charge of the battery between 80% and 75% will lead to a far more severe battery ageing phenomenon. Yet, compared to the condition where the battery capacity is not controlled at all, both the aging degrees of the battery shown by the characteristic curve 502 and the characteristic curve 503 are better than the aging degree of the battery shown by the characteristic curve 501. In the condition where the battery power management method in the embodiments of the invention is applied, the aging degree of the battery shown by the characteristic curve 503 is also better than the aging degree of the battery shown by the characteristic curve 501.

It is worth noting that, after the battery capacity of the battery is aged to be less than 50%, if the relative state of charge of the battery is continuously maintained between 60% and 55%, the amount of power in the battery will be quickly ran out after the external power source is removed, thereby affecting the user experience when the user operates the portable electronic apparatus. However, in the condition where the battery power management method in the embodiments of the invention is applied, after the battery capacity of the battery is aged to be less than 50%, by maintaining the relative state of charge within the high range between 80% to 75%, a usage time of the portable electronic apparatus without being plugged in may be extended to thereby improve the user experience when the user operates the portable electronic apparatus.

In summary, according to the embodiments of the invention, whether to charge the battery or not may be determined by detecting whether the discharge current of the battery is greater than the current threshold within the predetermined period. By doing so, the battery may be prevented from being repeatedly charged due to the self-discharge phenomenon so the operating life of the battery can be extended. In addition, according to the embodiments of the invention, if the discharge current of the battery is greater than the current threshold within the predetermined period, the battery will be controlled to be charged or discharged to maintain the relative state of charge of the battery within the particular power range. In this way, the aging speed of the battery may be slowed down by maintaining the relative state of charge of the battery within the particular power range. Moreover, by determining the particular power range according to the aging degree of the battery, the user experience may be further ensured while delaying the aging degree of the battery.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A battery power management method, adapted to a portable electronic apparatus having a battery, and comprising:
detecting a discharge current of the battery;
determining whether the discharge current is greater than a current threshold within a predetermined period;
if the discharge current is not greater than the current threshold within the predetermined period, determining whether a fully charge capacity of the battery is less than a battery capacity threshold;
if the fully charge capacity of the battery is not less than the battery capacity threshold, controlling a relative state of charge of the battery to be maintained within a first power range; and
if the fully charge capacity of the battery is less than the battery capacity threshold, controlling the relative state of charge of the battery to be maintained within a second power range.

2. The battery power management method according to claim 1, further comprising:
if the discharge current is greater than the current threshold within the predetermined period, controlling the battery to be charged until the battery is fully charged.

3. The battery power management method according to claim 1, wherein the battery capacity threshold is a product of a design capacity and a predetermined ratio of the battery.

4. The battery power management method according to claim 1, wherein if the fully charge capacity of the battery is not less than the battery capacity threshold, the step of controlling the relative state of charge of the battery to be maintained within the first power range comprises:
determining whether the relative state of charge of the battery is greater than a first threshold;
if the relative state of charge of the battery is greater than the first threshold, controlling the battery to be discharged until the relative state of charge of the battery is equal to the first threshold;
if the relative state of charge of the battery is not greater than the first threshold, determining whether the relative state of charge of the battery is less than a second threshold; and
if the relative state of charge of the battery is less than the second threshold, controlling the battery to be charged until the relative state of charge of the battery is equal to the first threshold.

5. The battery power management method according to claim 4, wherein if the fully charge capacity of the battery is less than the battery capacity threshold, the step of controlling the relative state of charge of the battery to be maintained within the second power range comprises:
determining whether the relative state of charge of the battery is greater than a third threshold;
if the relative state of charge of the battery is greater than the third threshold, controlling the battery to be discharged until the relative state of charge of the battery is equal to the third threshold;
if the relative state of charge of the battery is not greater than the third threshold, determining whether the relative state of charge of the battery is less than a fourth threshold; and
if the relative state of charge of the battery is less than the fourth threshold, controlling the battery to be charged until the relative state of charge of the battery is equal to the third threshold.

6. The battery power management method according to claim 5, wherein the third threshold is greater than the first threshold, and the fourth threshold is greater than the second threshold.

7. The battery power management method according to claim 1, further comprising:
after the relative state of charge of the battery is maintained within the first power range or the seconds power range, determining whether the portable electronic apparatus is connected to an external power source;
if the portable electronic apparatus is connected to the external power source, determining whether the fully charge capacity of the battery is less than the battery capacity threshold; and
if the portable electronic apparatus is not connected to the external power source, detecting the discharge current of the battery and determining whether the discharge current is greater than the current threshold within the predetermined period.

8. A portable electronic apparatus, comprising
a battery, supplying a power to the portable electronic apparatus;
a controller, controlling the battery to be charged or discharged, detecting a discharge current of the battery, and determining whether the discharge current is greater than a current threshold within a predetermined period,
wherein if the discharge current is not greater than the current threshold within the predetermined period, the controller determines whether a fully charge capacity of the battery is less than a battery capacity threshold;
if the fully charge capacity of the battery is not less than the battery capacity threshold, the controller controls a relative state of charge of the battery to be maintained within a first power range; and
if the fully charge capacity of the battery is less than the battery capacity threshold, the controller controls the relative state of charge of the battery to be maintained within a second power range.

9. The portable electronic apparatus according to claim 8, wherein if the discharge current is greater than the current threshold within the predetermined period, the controller controls the battery to be charged until the battery is fully charged.

10. The portable electronic apparatus according to claim 8, wherein the battery capacity threshold is a product of a design capacity and a predetermined ratio of the battery.

11. The portable electronic apparatus according to claim 8, wherein if the fully charge capacity of the battery is not less than the battery capacity threshold, the operation in which the controller controls the relative state of charge of the battery to be maintained within the first power range comprises:
the controller determines whether the relative state of charge of the battery is greater than a first threshold;
if the relative state of charge of the battery is greater than the first threshold, the controller controls the battery to be discharged until the relative state of charge of the battery is equal to the first threshold;
if the relative state of charge of the battery is not greater than the first threshold, the controller determines whether the relative state of charge of the battery is less than a second threshold; and
if the relative state of charge of the battery is less than the second threshold, the controller controls the battery to be charged until the relative state of charge of the battery is equal to the first threshold.

12. The portable electronic apparatus according to claim 11, wherein if the fully charge capacity of the battery is less than the battery capacity threshold, the operation in which the controller controls the relative state of charge of the battery to be maintained within the second power range comprises:
the controller determines whether the relative state of charge of the battery is greater than a third threshold;
if the relative state of charge of the battery is greater than the third threshold, the controller controls the battery to be discharged until the relative state of charge of the battery is equal to the third threshold;
if the relative state of charge of the battery is not greater than the third threshold, the controller determines whether the relative state of charge of the battery is less than a fourth threshold; and
if the relative state of charge of the battery is less than the fourth threshold, the controller controls the battery to be charged until the relative state of charge of the battery is equal to the third threshold.

13. The portable electronic apparatus according to claim 12, wherein the third threshold is greater than the first threshold, and the fourth threshold is greater than the second threshold.

14. The portable electronic apparatus according to claim 8, wherein after the relative state of charge of the battery is maintained within the first power range or the seconds power range, the controller determines whether the portable electronic apparatus is connected to an external power source;
wherein if the portable electronic apparatus is connected to the external power source, the controller determines whether the fully charge capacity of the battery is less than the battery capacity threshold; and
if the portable electronic apparatus is not connected to the external power source, the controller detects the discharge current of the battery and determines whether the discharge current is greater than the current threshold within the predetermined period.
